(19) United States
(12) Patent Application Publication
(10) Pub. No.: US 2026/0279930 A1
(43) Pub. Date: Sep. 17, 2026

(54) FUEL MOBILE BATTERY

(71) Applicant: Keone Trask, Greenville, SC (US)

(72) Inventor: Keone Trask, Greenville, SC (US)

(73) Assignee: Clear Touch Interactive, Inc., Greenville, SC (US)

(21) Appl. No.: 19/667,763

(22) Filed: May 5, 2026

Related U.S. Application Data
(62) Division of application No. 18/208,505, filed on Jun. 12, 2023.

(51) Int. Cl. H01M 10/42; H01M 10/46; H01M 50/233; H02J 7/00

(52) U.S. Cl. CPC H01M 10/425; H01M 10/46; H01M 50/233; H02J 7/855

(57) ABSTRACT

The present invention generally relates to a C-shaped mobile power supply designed primarily for use with powered mobile display device stands for use in locations without available or reliable electrical power, but the invention may be used in other locations as well. The power supply is specifically C-shaped to adapt to many commonly used mobile display stands. The power supply includes a housing set low to the ground for greater stability wherein all the components are housed, comprising a battery, inverter, charger, power input and power output. The battery may be sized to provide power to the display device, as well as additional peripherals. Computer software is optionally included to control and monitor all functionality of the system.

### CROSS-REFERENCE TO RELATED APPLICATIONS

This application is a divisional of U.S. patent application Ser. No. 18/208,505, filed Jun. 12, 2023. This application claims priority to now expired U.S. Provisional Patent Application No. 63/088,727, filed Oct. 7, 2020; and U.S. patent application Ser. No. 17/480,927, filed on Sep. 21, 2021; all of which are incorporated herein by reference.

The present invention generally relates to systems and methods of providing mobile power supply and, more particularly, to a C-shaped mobile power supply designed primarily for use with display carts to transport and use computers, displays, and other electronic devices in locations without available or reliable electrical power.

### BACKGROUND OF THE INVENTION

Educational institutions have transitioned over the past two generations away from chalk board use, first to marker boards and now to touchscreens. In most cases, a classroom has plenty of electrical receptacles, so it is not generally necessary to provide a power source for touchscreens. In some cases, however, power is not readily available and not always reliable. In those situations, an independent power source is necessary to use a touchscreen display or other electronic device.

The same is true of trade show displays. Often electrical power is unreliable or even unavailable in trade show galleries.

Moreover, a great deal of marketing could be enhanced with electronic displays in locations that are often too remote to provide an electrical power supply. Even temporary marketing, for example, may be needed in a remote location with no available power. A sidewalk A-frame display, for example, might be replaced entirely with a flat screen to provide more information to attract potential customers.

And finally, the same is true of virtually all mobile marketing. Take, for example, an interactive video display that requires standard electrical power. If a user were able to take that interactive display and place it onto a mobile, self-powered cart, then the user could walk around a trade show, taking the display directly to potential customers. Testing has shown that the instant invention may be used for this specific purpose with great success.

If a classroom, boardroom, trade show, or other area is without electrical receptacles, or reliable power, a mobile display user must either (1) retrieve and connect a power cord and run it all the way from another room to the room where the mobile display is used, or (2) forego use of the mobile display. A system and method that provides a reliable and mobile power supply would prevent these problems.

For maximum effectiveness, the mobile power supply should also be designed and shaped to fit current device carts, towers, and other stands. Current display device carts and stands operate on the same principles that they have for generations. They provide a cart designed to hold a TV or monitor with wheels on the bottom of the cart. The C-shaped mobile power supply should integrate seamlessly with such carts.

Prior art solutions also fail to provide a multitude of connections and sufficient power to accommodate the large variety of power plugs used by computers, laptops, cellular devices, and other peripherals that are generally used with mobile displays. For example, even if a mobile powered cart were available, it would still have to provide additional power to a laptop or other ancillary device that connects to the monitor. Otherwise, the monitor would be the only device powered. In other words, prior art solutions have not provided a solution to these issues sufficient for using a touchscreen monitor in some situations and in some locations.

What is needed is a C-shaped mobile power supply that provides an independent, reliable power source for use with prior art and other carts, stands and the like so as to provide electrical power for operation of electronic devices even where electrical power is unavailable or unreliable. A system and method that provides independent, reliable power would allow continuous use of electronic devices if the solution were portable with the electronic device.

What is also needed is a C-shaped mobile power supply that provides power, not only for a standard electronic display device, but also for a multitude of peripheral devices needed in conjunction with a display device.

What is also needed is a monitoring and control system for the mobile power supply. This system could reside directly within a processor located on the mobile power supply and be used to monitor and control all of the electronic components housed in the power supply.

What is also needed is an asset management system for use with an inventory of mobile power supplies. Such a system would provide monitoring and control of a multitude of mobile power supplies, along with their individual components. Such a system would, for example, determine the precise location of each mobile power supply in an inventory so that a user could monitor the parameters for performance and maintenance. That would also allow the user to program a variety of theft prevention measures into the device. It could also be used to control each mobile power supply and each of its components. It could even be used to update the software contained on each component in the entire inventory, individually or as a group.

An object of the present invention is to provide a C-shaped mobile power supply for production of independent, reliable power so as to power a multitude of electronic devices when electrical power is unavailable or unreliable in a specific location or condition.

Another object of the present invention is to provide a C-shaped mobile power supply that provides power, not only for a standard electronic display device, but also for a multitude of peripheral devices needed in conjunction with a display device.

Yet another object of the present invention is to provide a C-shaped mobile power supply that is designed to fit onto and used by prior art and other carts, stands and the like so as to provide electrical power for operation of electronic devices even where electrical power is unavailable or unreliable.

Yet another object of the present invention is to provide a monitoring and control system for the mobile power supply to monitor and control all the electronic components housed in the power supply.

Yet another object of the present invention is to provide an asset management system for use with an inventory of mobile power supplies. Such a system would provide monitoring and control of a multitude of mobile power supplies, along with their individual components.

### SUMMARY OF THE INVENTION

The present invention accomplishes the foregoing objects by providing the Fuel Mobile Battery, which comprises a charger, battery and inverter housed within a C-shaped housing, designed to fit onto and used by prior art and other carts, stands and the like so as to provide electrical power for operation of electronic devices even where electrical power is unavailable or unreliable.

The present invention further accomplishes the foregoing objects by providing a mobile power supply, comprising: a C-shaped housing, comprising: a housing cover and a power supply comprising: a battery, an inverter, a charger, a power outlet for providing power, and a power inlet for charging said battery.

This embodiment of the system may further comprise a processor for monitoring a multiplicity of parameters associated with one or more of said battery, said inverter, said power outlet, said power inlet, and said charger.

This embodiment of the system may further comprise a processor for control of one or more of said battery, said inverter, said power outlet, said power inlet, and said charger.

This embodiment of the system may further comprise a communications port for providing wired communication with a peripheral device.

This embodiment of the system may further comprise a communications port for providing wireless communication with a peripheral device.

This embodiment of the system may further comprise a port for providing wired charging of a peripheral device.

This embodiment of the system may further comprise a display for indicating a status of said battery.

This embodiment of the system may further comprise a multiplicity of wheels affixed to the bottom of said housing so as to provide mobility for said housing.

This embodiment of the system may further comprise a mount for an electronic display.

This embodiment of the system may further comprise a mount for a computing device.

This embodiment of the system may further comprise a power outlet for providing power is a non-standard power outlet so as to prevent unwanted use of the system.

The present invention accomplishes the foregoing objects by providing a method of using a mobile power supply comprising the steps of: providing a C-shaped housing comprising therein: a C-shaped housing cover, a power supply comprising: a battery, an inverter, a charger, a power outlet for providing power, and a power inlet for charging said battery; attaching said power inlet to a separate power source to charge said battery using said inverter; and attaching an electronic device to said power outlet to provide power to said electronic device.

This embodiment of the method may optionally provide a housing further comprises a processor for monitoring a multiplicity of parameters associated with one or more of said battery, said inverter, said power outlet, said power inlet, and said charger.

This embodiment of the method may optionally provide a housing further comprising a processor for control of one or more of said battery, said inverter, said power outlet, said power inlet, and said charger.

This embodiment of the method may comprise the step of using a processor to monitor one or more parameters of said battery.

This embodiment of the method may comprise a display for indicating a status of said battery.

This embodiment of the method may comprise the step of using a processor to monitor one or more parameters of said inverter.

This embodiment of the method may comprise a display for indicating a status of said inverter.

This embodiment of the method may comprise the step of using a processor to monitor one or more parameters of said power inlet.

This embodiment of the method may vary wherein said housing further comprises a multiplicity of wheels affixed to the bottom of said housing so as to provide mobility for said housing.

This embodiment of the method may vary wherein said housing further comprises a communications port and cable for providing wired communication with a peripheral device.

This embodiment of the method may vary wherein said housing further comprises a communications port for providing wireless communication with a peripheral device.

This embodiment of the method may vary wherein said housing further comprises a mount for an electronic display.

This embodiment of the method may vary wherein said housing further comprises a mount for a computing device.

This embodiment of the method may vary wherein said housing further comprises a display for indicating a status of said power inlet.

This embodiment of the method may further comprise the step of using a processor to monitor one or more parameters of said power outlet.

This embodiment of the method may vary wherein said power outlet for providing power is a non-standard power outlet so as to prevent unwanted use of the system.

This embodiment of the method may further comprise the step of attaching said housing to a stand designed for use with electronic display devices.

This embodiment of the method may vary wherein said housing further comprises an additional said power outlet for providing power to a peripheral device.

The present invention accomplishes the foregoing objects by providing a non-transitory computer readable medium encoded with a computer program comprising instructions that when executed by one or more processors cause the one or more processors to perform operations comprising the steps of: providing status information of one of a multiplicity of controllable parameters in a mobile power supply, comprising a C-shaped housing, comprising therein a power supply, comprising: a battery; an inverter; a charger; a power outlet for providing power from said battery using said inverter, and a power inlet for charging said battery using said charger.

The present invention accomplishes the foregoing objects by providing a non-transitory computer readable medium encoded with a computer program comprising instructions that when executed by one or more processors cause the one or more processors to perform operations comprising the steps of: providing control of one of a multiplicity of controllable parameters in a mobile power supply, comprising a C-shaped housing, comprising therein a power supply, comprising: a battery; an inverter; a charger; a power outlet for providing power from said battery using said inverter, and a power inlet for charging said battery using said charger.

This embodiment of the method may further comprise the step providing updates for software residing in one or more components of said mobile power supply.

This embodiment of the method may further comprise the step providing control of a display cart.

This embodiment of the method may further comprise the step providing articulating control of said display cart.

This embodiment of the method may further comprise the step of providing angle control of said display cart.

The present invention accomplishes the foregoing objects by providing a non-transitory computer readable medium encoded with a computer program comprising instructions that when executed by one or more processors cause the one or more processors to perform operations comprising the steps of: determining the location of a mobile power supply, comprising therein a power supply, comprising: a battery; an inverter; a charger; a power outlet for providing power from said battery using said inverter, and a power inlet for charging said battery using said charger; and outputting said location when requested.

This embodiment of the method may further comprise the step of sounding an audible alarm in response to determining that said mobile power supply is not in a designated location.

This embodiment of the method may further comprise the step of sending an electronic message to a designated account upon determining that said mobile power supply is not in a designated location.

This embodiment of the method may further comprise the step of using said location to provide asset management for an inventory comprising said mobile power supply.

The present invention accomplishes the foregoing objects by providing a non-transitory computer readable medium encoded with a computer program comprising instructions that when executed by one or more processors cause the one or more processors to perform operations comprising the step of providing asset management for an inventory one or more mobile power supplies.

This embodiment of the method may vary wherein the step of providing asset management for an inventory of one or more mobile power supplies, further comprises the step of tracking the location of said one or more mobile power supplies.

This embodiment of the method may vary wherein the step of providing asset management for an inventory of one or more mobile power supplies, further comprises the step of updating software residing on one or more components of said one or more mobile power supplies.

### DESCRIPTION OF THE DRAWINGS

The invention will be more readily understood with reference to the following specification in conjunction with the drawings herein:

FIG. 1 is a top perspective view of a mobile power supply system according to a preferred embodiment of the invention.

FIG. 2 is an interior perspective view of a mobile power supply system according to a preferred embodiment of the invention.

FIG. 3 is a view of a portion of the base in a mobile power supply system according to a preferred embodiment of the invention.

FIG. 4 is a view of a portion of the base in a mobile power supply system according to a preferred embodiment of the invention.

FIG. 5 is a front view of the mobile power supply system in use according to a preferred embodiment of the invention.

FIG. 6 is a rear view of the mobile power supply system in use according to a preferred embodiment of the invention.

### DESCRIPTION OF THE PREFERRED EMBODIMENTS

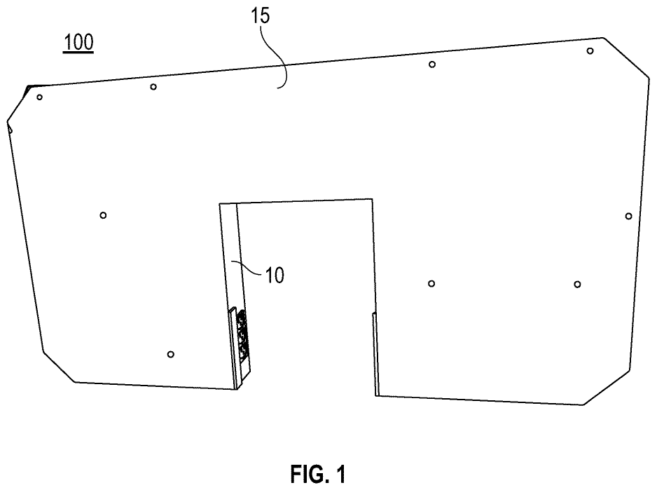

Referring now to FIG. 1, a top perspective view of a system 100 is provided for a mobile power supply system according to a preferred embodiment of the invention. A C-shaped housing 10 is provided with a housing cover 15 as pictured.

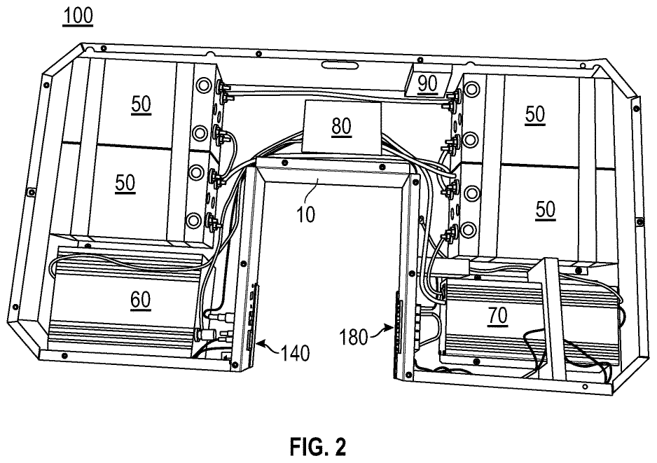

Referring now to FIG. 2, an interior perspective view of a system 100 is provided for a mobile power supply system according to a preferred embodiment of the invention with cover 15 removed to illustrate the internal components. Contained within the housing 10 are a multi-part battery 50, inverter 60, charger 70, electrical output 180 and electrical input 140. Also contained in the housing is processor and controller 80, which is optionally configured to monitor and control all of the components withing housing 10. A speaker 90 may also be provided for audible output.

Multiple reasons exist for placing all these items inside the housing 10 and under cover 15. First, batteries, chargers, and inverters tend to be heavy, so placing them inside housing 10, all spread out and flat to the ground, moves the center of gravity for system 100 very low to the ground. This makes the device far more stable. This aspect of the invention is an essential improvement over the prior art because the C-shaped mobile power supply is shaped to fit modern display carts, although it can be used in many other applications. Electronic displays continue to be manufactured in larger, heavier models, whereby the absence of this large weight—all within the housing and all low to the ground, to create a low center of gravity—would provide little functionality for modern display carts.

Second, this is the most logical place to create a reinforced case, i.e., housing 10. One of the target customers for this device is educational institutions. That means that students can reasonably be expected to climb on housing 10 from time to time. Another target customer is any company that often displays at trade shows, where multiple additional items might be stacked onto the housing as part of the display. As such, housing 10 further includes significant reinforcements within to withstand crushing forces from a people and other heavy items standing on its surface.

Third, a simple housing cover 15 is easy to remove in situations where a customer wants to access the battery to add or subtract cells. A preferred embodiment of the invention includes a battery with 4 Li ion cells but is easily upgraded to 8 cells when needed. A reinforced case with such a cover is also a better place to put heavy items such as batteries, chargers, and inverters so that they are more secure.

In normal use, battery 50 is charged operatively connected to charger 70 when mobile power supply 100 is plugged into a standard receptacle using a cable (not pictured) attached to power input 140. Battery 50 is also operatively connected to inverter 60 for power output, whereby electrical power is output through inverter 60 using power output 180. In a preferred embodiment of the invention as shown in FIGS. 1 and 2, power input 140 may be attached to a standard 110 VAC power cable, and power output 180 may supply power to a 110 VAC power plug.

As pictured, battery 50 takes up approximately 80% of the available space within housing 10. Different sizes and types of batteries may be employed for different uses. Testing has shown that up to 12 hours of power is readily available for a 65″ touchscreen, where a series of cells in a Li ion battery is enclosed within housing 10 with a width of approximately 48″, depth of approximately 24″ and height of approximately 4″. As this is a more expensive configuration, smaller and cheaper batteries may be employed for different pricing structures and applications.

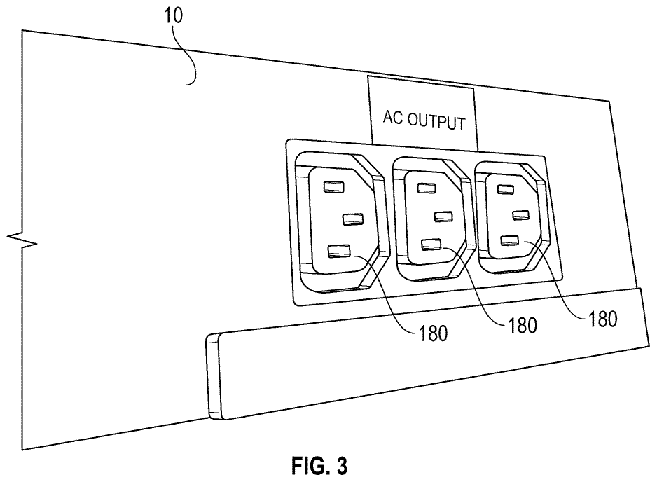

Referring now to FIG. 3, a portion of the housing 10 of a mobile power supply system is shown in closer perspective to better illustrate power output 180. Testing of prototypes of the invention has shown that power output 180 is preferably a series of non-standard plugs, such as IEC-C13 plugs. Because the invention is especially useful where no reliable power is available, others are often tempted to surreptitiously plug into the mobile power supply if the 110 VAC power plug is the standard type used in common connections, such as a 15 A TR receptacle. The use of non-standard plugs, such as C13 plugs, has been shown to prevent unwanted use of the invention because few parties travel with a C13-to-pstandard adapter. A preferred embodiment of the invention, therefore, requires the use of an IEC-320-C14 to NEMA 5-15R power cord to connect with the IEC C13 power outlets illustrated as power output 180 in FIG. 3.

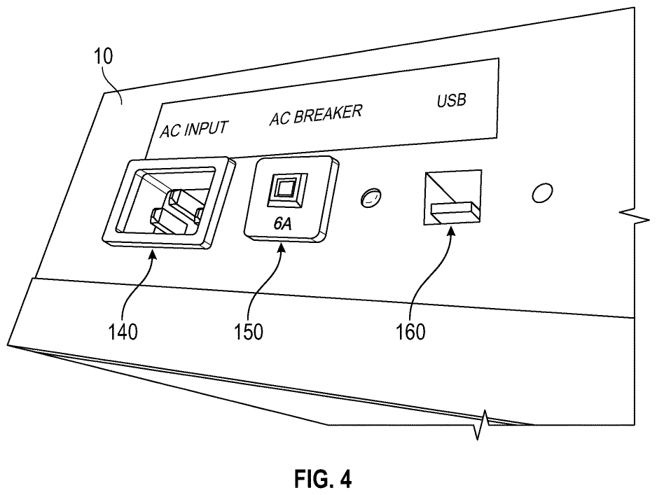

Referring now to FIG. 4, another portion of the housing 10 of a mobile power supply system is shown in closer perspective. A power input 140 is pictured. This input accepts a power cable to charge the battery within housing 10. A preferred embodiment of the invention uses an IEC-C14 power plug input as pictured because most computers and other peripherals use C14 plugs. A circuit breaker 150 is preferably added to detect faults and prevent electrical overload of the system. Communications port 160 provides a wired pathway to connect power supply 100 to a peripheral device (not pictured) or other electronic device, and preferably to a display device. In another embodiment of the invention, a multitude of communication ports 160 can be added to provide power and charging ports for peripheral devices.

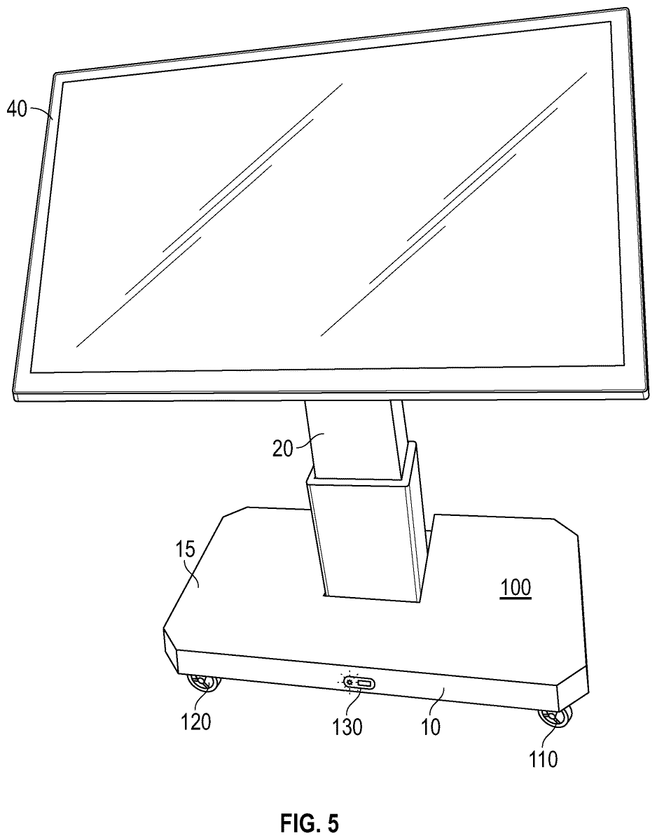

Referring now to FIG. 5, the mobile power supply system 100 is displayed in use on a modern display cart from the front angle. Here, the need for a C-shaped housing 10 is evident in this application, whereby the housing fits uniformly around the base of the display cart with weight distributed equally from side-to-side and front-to-back. Display device 40 is pictured as attached to an extendable and articulating neck 20.

In this embodiment, optional casters (also called wheels) 110 may be added to the housing 10 for increased mobility. A preferred embodiment also includes locking casters 120. An additional embodiment includes a battery status indicator 130 for quick visual reference while power supply 100 is in use.

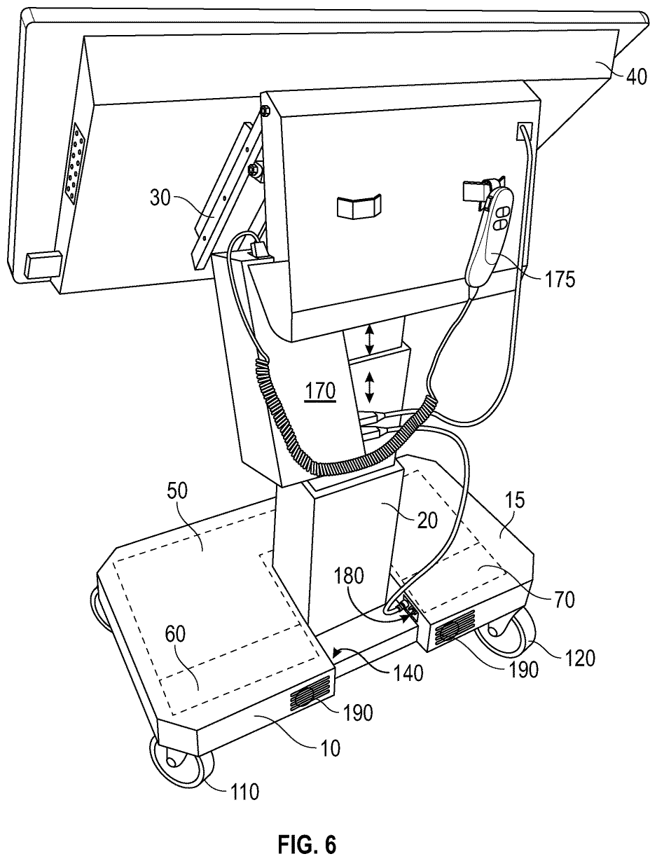

Referring now to FIG. 6, the mobile power supply system is displayed in use on a modern display cart from the back angle. Housing 10 again incorporates casters 110 and 120 for mobility. Here, however, you can see access to power input 140 and power output 180, along with ventilation portals 190 on opposite sides of housing 10. The positions of battery 50, inverter 60, and charger 70—each disposed beneath cover 15—are shown in outline.

From this angle one can also better view the components of a modern articulating display cart. Articulating neck 20 connects to housing 10, then extends upwards to mounting plate 30 for mounting display 40. Controller 170 is used to raise and lower the display, as well as change its angle. Controller 170 may optionally contain a wireless controller for access and control via wireless means, such as a cellular phone application. Controller 170 may also be controlled via wired access through hand controller 175.

In another embodiment of the invention, the display device includes software that allows a user to perform multiple functions using touchscreen commands on the display device. More specifically, a preferred embodiment of the invention comprises software that provides user control of a multiplicity of controllable parameters in a powered device stand using a display device such as a touchscreen monitor. An Android or iOS application is downloadable on a standard touchscreen device. The application is easily configured to perform multiple functions with the display cart including, without limitation articulation controls for controller 170 to adjust the viewing angle and height of the display device.

In another preferred embodiment, an Android or iOS application is downloadable on a standard touchscreen device to control the mobile power supply 100 using processor 80 pictured in FIG. 2. The application is easily configured to communicate with processor 80 to perform multiple functions including, without limitation: (1) power use and status monitoring, (2) programmable alarms for battery use and performance parameters, (3) programable power on and off based on battery and inverter status, (4) battery life, half-life, performance, etc., and (5) presets for all parameters of the display device, battery, viewing angle and height, shutdown, charging, etc. A preferred embodiment of system 100 includes all of the above functionality for both the mobile power supply 100 and controller 170.

Another important aspect of one embodiment of the invention, is the optional asset control provided by the software for mobile power supply 100. In a preferred embodiment of the invention, the software allows users with multiple mobile power supplies to monitor and track both the performance and the location of each mobile power supply. This in turn allows for asset tracking of the display devices and carts in most cases since they are generally used together. In other words, a user such as a school, or even an entire school district, may use the software to monitor both the performance and the actual location of each mobile power supply. This provides tremendous advantages that not only allows for group updates of software, but also provides an important location tracking function through processor 80. Location tracking allows a user to not only locate all devices, but also allows for important functions, such as anti-theft protections and asset allocation.

In a typical scenario, this asset tracking function can be set to issue an alarm if an asset is removed from its designated area, thereby providing an early alarm to prevent theft or misuse. In a preferred embodiment, the alarm: (1) sounds directly on power supply 100 itself using speaker 90 to provide an audible alert that the mobile power supply asset is not in its proper location or may be in the process of being stolen, and (2) simultaneously issues a text and email to designated accounts for appropriate personnel. Because the software also takes advantage of modern tracking functions, and because the mobile power supply is self-powered, appropriate personnel may then contact the authorities and give them the location of stolen properties.

The asset management software can also provide typical I/T functions such as software monitoring, control, and updates for individual or groups of components in one or more mobile power supplies, display carts, displays, computers, peripherals and the like.

The invention has been described with reference to the preferred embodiments without limit thereto. Additional embodiments and improvements may be realized which are not specifically set forth herein but which are within the scope of the invention as more specifically set forth in the claims appended hereto.

1. A method of using a mobile power supply comprising the steps of:
providing a C-shaped housing comprising therein:
a housing cover,
a power supply comprising:
a battery,
an inverter,
a charger,
a power outlet for providing power, and
a power inlet for charging said battery;
attaching said power inlet to a power source to charge said battery using said inverter; and
attaching an electronic device to said power outlet to provide power to said electronic device.

2. The method of claim 1, wherein said housing further comprises a processor for monitoring a multiplicity of parameters associated with one or more of said battery, said inverter, said power outlet, said power inlet, said charger, and a speaker.

3. The method of claim 1, wherein said housing further comprises a processor for control of one or more of said battery, said inverter, said power outlet, said power inlet, said charger, and a speaker.

4. The method of claim 1, further comprising the step of using a processor to monitor one or more parameters of said battery.

5. The method of claim 1, wherein said housing further comprises a display for indicating a status of said battery.

6. The method of claim 1, further comprising the step of using a processor to monitor one or more parameters of said inverter.

7. The method of claim 1, wherein said housing further comprises a display for indicating a status of said inverter.

8. The method of claim 1, further comprising the step of using a processor to monitor one or more parameters of said power inlet.

9. The method of claim 1, wherein said housing further comprises a multiplicity of wheels affixed to the bottom of said housing so as to provide mobility for said housing.

10. The method of claim 1, wherein said housing further comprises a communications port and cable for providing wired communication with a peripheral device.

11. The method of claim 1, wherein said housing further comprises a communications port for providing wireless communication with a peripheral device.

12. The method of claim 1, wherein said housing further comprises a mount for an electronic display.

13. The method of claim 1, wherein said housing further comprises a mount for a computing device.

14. The method of claim 1, wherein said housing further comprises a display for indicating a status of said power inlet.

15. The method of claim 1, further comprising the step of using a processor to monitor one or more parameters of said power outlet.

16. The method of claim 1, wherein said power outlet for providing power is a non-standard power outlet so as to prevent unwanted use of the system.

17. The method of claim 1, further comprising the step of attaching said housing to a stand designed for use with electronic display devices.

18. The method of claim 1, wherein said housing further comprises an additional said power outlet for providing power to a peripheral device.

19. A non-transitory computer readable medium encoded with a computer program comprising instructions that when executed by one or more processors cause the one or more processors to perform operations comprising:
providing status information of one of a multiplicity of controllable parameters in a mobile power supply, comprising a C-shaped housing, comprising therein a power supply, comprising:
a battery;
an inverter;
a charger;
a power outlet for providing power from said battery using said inverter, and
a power inlet for charging said battery using said charger.

20. A non-transitory computer readable medium encoded with a computer program comprising instructions that when executed by one or more processors cause the one or more processors to perform operations comprising:
providing control of one of a multiplicity of controllable parameters in a mobile power supply, comprising a C-shaped housing, comprising therein a power supply, comprising:
a battery;
an inverter;
a charger;
a power outlet for providing power from said battery using said inverter, and
a power inlet for charging said battery using said charger.

21. The method of claim 19, further comprising the step of providing updates for software residing in one or more components of said mobile power supply.

22. The method of claim 19, further comprising the step of providing control of a display cart.

23. The method of claim 21, further comprising the step of providing articulating control of said display cart.

24. The method of claim 21, further comprising the step of providing angle control of said display cart.

25. A non-transitory computer readable medium encoded with a computer program comprising instructions that when executed by one or more processors cause the one or more processors to perform operations comprising:
determining the location of a mobile power supply, comprising therein a power supply, comprising:
a battery;
an inverter;
a charger;
a power outlet for providing power from said battery using said inverter, and
a power inlet for charging said battery using said charger; and
outputting said location when requested.

26. The method of claim 25, further comprising the step of sounding an audible alarm in response to determining that said mobile power supply is not in a designated location.

27. The method of claim 25, further comprising the step of sending an electronic message to a designated account upon determining that said mobile power supply is not in a designated location.

28. The method of claim 25, further comprising the step of using said location to provide asset management for an inventory comprising said mobile power supply.

29. A non-transitory computer readable medium encoded with a computer program comprising instructions that when executed by one or more processors cause the one or more processors to perform operations comprising providing asset management for an inventory one or more mobile power supplies.

30. The method of claim 29, wherein the step of providing asset management for an inventory of one or more mobile power supplies, further comprises the step of tracking the location of said one or more mobile power supplies.

31. The method of claim 29, wherein the step of providing asset management for an inventory of one or more mobile power supplies, further comprises the step of updating software residing on one or more components of said one or more mobile power supplies.
